(19) United States
(12) Patent Application Publication
(10) Pub. No.: US 2019/0191838 A1
(43) Pub. Date: Jun. 27, 2019

(54) SWITCHABLE DECOR

(71) Applicant: Swaponz, Inc., Natick, MA (US)

(72) Inventor: Patrick Planche, Natick, MA (US)

(21) Appl. No.: 16/287,405

(22) Filed: Feb. 27, 2019

Related U.S. Application Data
(63) Continuation-in-part of application No. 15/467,681, filed on Mar. 23, 2017, now abandoned.
Application No. 15/467,681 is a continuation-in-part of application No. 15/351,613, filed on Nov. 15, 2016, now Pat. No. 9,867,439.
Application No. 15/351,613 is a continuation-in-part of application No. 14/920,198, filed on Oct. 22, 2015, now Pat. No. 9,510,656.
Application No. 14/920,198 is a continuation of application No. 13/832,903, filed on Mar. 15, 2013, now Pat. No. 9,199,432.

(51) Int. Cl. A45C 11/00; C09J 7/00; B44C 1/10; B32B 7/12; C09J 7/38; B29C 63/00; B32B 7/06; H04B 1/3888

(52) U.S. Cl. CPC A45C 11/00; C09J 7/00; B44C 1/10; B32B 7/12; C09J 7/38; B29C 63/0013; B29L 2031/3437; H04B 1/3888; B32B 2307/748; B32B 2250/40; B32B 2405/00; B32B 2451/00; B32B 7/06

(57) ABSTRACT

An apparatus comprises an article including a non-flat or non-rigid surface, a decorative sheet member and a fixation sheet member. The decorative sheet member has a first side and a second side, neither of the first and second sides having an adhesive. The fixation sheet member has a third side configured to be attached to the outer surface of the article, the third side including a permanent bonding agent with a first adhesion characteristic, and a fourth side, opposite the third side and configured to receive one of the first and second sides of the decorative sheet, the fourth side having a repositionable material with a second adhesion characteristic, the second adhesion characteristic being less permanent than the first adhesion characteristic.

### CROSS REFERENCE TO RELATED APPLICATION

This application is a continuation-in-part of U.S. application Ser. No. 15/467,681 filed on Mar. 23, 2017, which is a continuation-in-part of U.S. application Ser. No. 15/351,613 filed on Nov. 15, 2016, which is a continuation-in-part of U.S. application Ser. No. 14/920,198 filed on Oct. 22, 2015, which is a continuation of U.S. application Ser. No. 13/832,903, filed on Mar. 15, 2013, the contents of all which are hereby incorporated by reference in their entirety.

### BACKGROUND

This invention relates to covers that are attached to devices, for example, to protect or decorate devices.

Many consumer products, including portable devices (e.g., electronic mobile devices, toys) as well as clothing (shirts, hats) and equipment, are desirably customized to allow the owner to more easily distinguish their device from other products thereby facilitating identification and personalization of his/her device.

For example, in the portable electronic device market, a wide variety of cases and “skins” (i.e., thin sticker with adhesive) are available for covering cell phones, smartphones, laptop computers and tablet computers. These cases also allow owners to personalize their equipment and express themselves.

When the cover becomes worn or when the owner of the device grows tired of the image or graphical design on the device, the cover is replaced or in the case of a skin, stripped from the housing of the device.

### SUMMARY

In a general aspect of the invention, an apparatus comprises an article including a non-flat (e.g., curved) or non-rigid surface, a decorative sheet member and a fixation sheet member. The decorative sheet member has a first side and a second side, neither of the first and second sides having an adhesive. The fixation sheet member has a third side configured to be attached to the outer surface of the article, the third side including a permanent bonding agent with a first adhesion characteristic, and a fourth side, opposite the third side and configured to receive one of the first and second sides of the decorative sheet, the fourth side having a repositionable material with a second adhesion characteristic, the second adhesion characteristic being less permanent than the first adhesion characteristic.

Embodiments of these aspects of the invention may include one or more of the following features. The decorative sheet member and the fixation sheet member are configured such that when the decorative sheet member is removed from the fourth side of the fixation sheet, the repositionable material remains on the fourth side of the fixation sheet member.

The decorative sheet member is formed of a first material, the fixation sheet member is formed of a second material and the repositionable material adheres more strongly to the second material than to the first material.

The decorative sheet member has a predetermined dimension that is commensurate in size with a predetermined dimension of the fixation sheet member.

The decorative sheet member has a thickness a range between 4 mil (0.004 inch) and 50 mil (0.050 inch).

The first side of the decorative sheet member includes a photographic, graphical or textual image.

The fourth side has a first region including the repositionable material and a second region that does not include the repositionable non-adhesive material. The second region has a first predetermined shape.

The non-rigid surface of the article is formed of fabric. In some embodiments, the article is in the form of a clothing (e.g. a shirt or hat). In other embodiments, the article is a toy (e.g., stuffed animal toy).

The repositionable material may be an adhesive or a non-adhesive (e.g., including microspheres).

The fixation sheet member includes a frame region surrounding a central region. In some embodiments, the central region has the second adhesion characteristic and the frame region has a third adhesion characteristic greater than the second adhesion characteristic. Alternatively, in other embodiments, the central region has the second adhesion characteristic and the frame region has a third adhesion characteristic less than the second adhesion characteristic.

Among other advantages, an apparatus includes a fixation sheet member having enough tackiness for the decorative sheet member (i.e., the switchable decor) to stay secured in place while being able to switch easily the decorative sheet member for another decorative sheet member. To promote this result, in certain embodiments, the fixation sheet member has different shapes and areas devoid of repositionable material (which may be adhesive or non-adhesive) to balance tackiness and switch-ability.

Other features and advantages of the invention are apparent from the following description, and from the claims.

### DESCRIPTION OF DRAWINGS

FIG. 1 is an exploded perspective view of a switchable decor used in conjunction with a smartphone.

FIG. 2 is a plan view of the front face of the case of FIG. 1 including a fixation sheet.

FIG. 3 is a cross-sectional view of the fixation sheet shown in FIG. 2.

FIG. 4 is a plan view of the rear side of the case.

FIG. 5 is a cross-sectional end view along lines 3-3 of FIG. 4.

FIG. 6 is a perspective view of a suction tool for use in removing the switchable decor from the case.

FIG. 7 illustrates the use of the suction tool of FIG. 6 in removing the switchable decor from the case.

FIG. 8 is an alternative embodiment of a system having a switchable decor used in conjunction with a smartphone.

FIG. 9 is an exploded perspective view of another alternative of a switchable decor used in conjunction with a smartphone.

FIG. 10 is an exploded perspective view of yet another alternative of a switchable decor used in conjunction with a smartphone.

FIG. 11 is a top view of an alternative embodiment of a second fixation sheet.

FIG. 12 is a cross-sectional side view of the second fixation sheet of FIG. 11 with articles attached thereto.

FIG. 13 is a functional flow diagram of a smartphone used in conjunction with a switchable decor of the type shown in FIGS. 1-2.

FIG. 14 is a block diagram of the smartphone shown in FIG. 13.

FIGS. 15A and 15B illustrate an example of using an application stored on the smartphone of FIGS. 13 and 14.

FIGS. 16A and 16B illustrate another example of using an application stored on the smartphone of FIGS. 13 and 14.

FIGS. 17A and 17B illustrate still another example of using an application stored on the smartphone of FIGS. 13 and 14.

FIG. 18 illustrates still another example of using an application stored on the smartphone of FIGS. 13 and 14.

FIG. 19 illustrates yet another example of using an application stored on the smartphone of FIGS. 13 and 14.

FIG. 20 is a plan view of a switchable decor used in conjunction with a T-shirt.

FIG. 21 is a plan view of an embodiment of a fixation sheet for use with a non-rigid product, such as the T-shirt of FIG. 20.

FIG. 22 is a plan view of an alternate embodiment of a fixation sheet for use with a non-rigid product.

FIG. 23 is a plan view of yet another embodiment of a fixation sheet for use with a non-rigid product.

FIG. 24 illustrates use of a switchable decor used in conjunction with a hat.

FIG. 25 illustrates still another embodiment of a fixation sheet having an embossed support frame for use with a non-rigid or curved product.

FIG. 26 illustrates another embodiment of a fixation sheet having a support with different tackiness for use with a non-rigid or curved product.

### DESCRIPTION

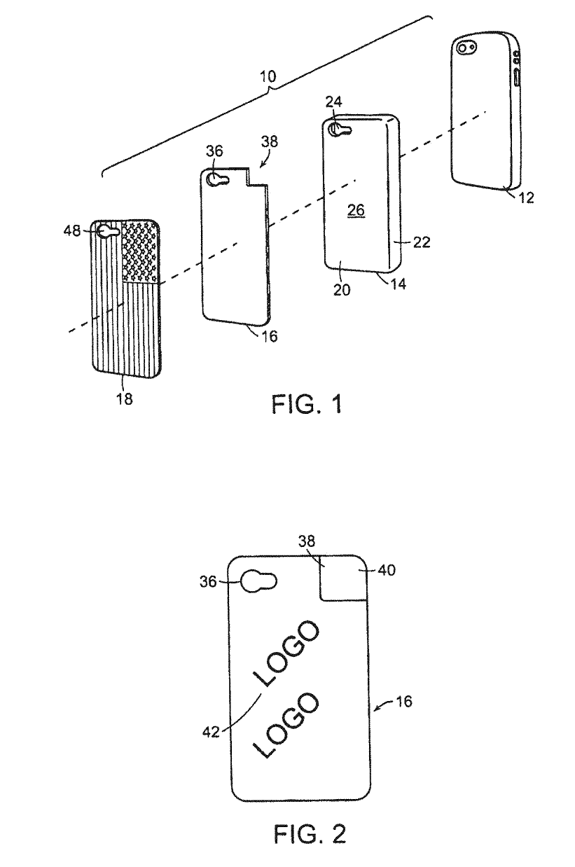

Referring to FIG. 1, a system 10 for protecting and decorating a smartphone 12 includes a protective case 14, a fixation sheet 16 and a decorative covering, referred to here as a switchable decor 18. In this embodiment, the case 14 is formed of relatively rigid and molded plastic but could also be formed of metal or wood and is sized to receive smartphone 12. In particular, case 14 includes a backwall 20 and four side walls 22 which in aggregate form a shell that essentially encloses cell phone 14. Side walls 22 may include openings or cutouts to allow access to switches and connections for charging, headphones, etc. on smartphone 12. Member 20 also includes an opening 24 so as not to block or conceal the camera lens of the smartphone 12. As will be described in greater detail below, case 14 is sized and shaped to receive switchable decor 18. Furthermore, case 14 includes a rear surface that opposes the outer surface of smartphone 12 and when attached to the smartphone forms a cavity 49 (FIG. 5) that is used to store additional decors 18.

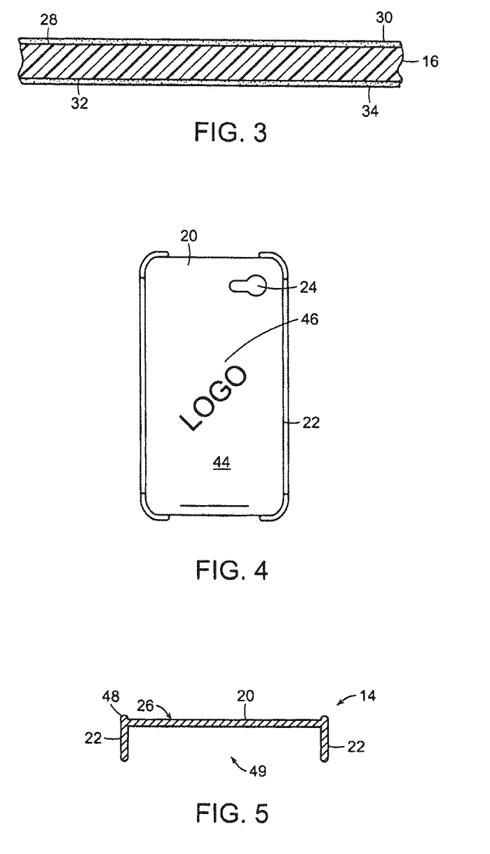

Referring to FIGS. 2 and 3, system 10 includes a fixation sheet 16 formed of relatively thin (2-5 mils) plastic or paper and sized to attached to a front surface 26 of case 14. A rear surface 28 of fixation sheet 16 includes a relatively strong adhesive 30 so that when positioned on front surface 26 of case 14, fixation sheet is, for most practical circumstances, permanently affixed to case 14. One example of a suitable relatively permanent adhesive is Ref. No. 204, manufactured by Polykote Corporation, Easton, Pa.

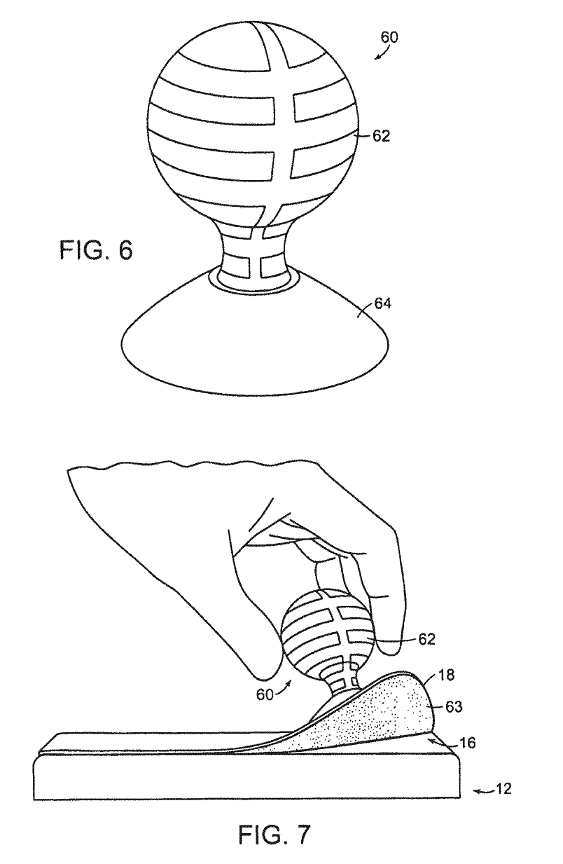

On the other hand, fixation sheet 16 includes on a front surface 32 a non-permanent adhesive 34 that is less strong than adhesive 30 used on rear surface 28. Fixation sheet 16 also includes an opening 36 sized commensurately with opening 24 of case 14. For reasons that will be discussed in greater detail below in conjunction with FIG. 6, fixation sheet also includes a cutout 38 such that a portion 40 of front surface 26 of case 14 is exposed and not covered with an adhesive. In this embodiment, the cutout 38 is provided so that exposed portion 40 of case 14 is in a corner of the case.

In this embodiment, non-permanent adhesive 34 is a microsphere adhesive composed of tiny spheres. The tiny spheres measure 10 to 250 microns in diameter and form a discontinuous film to limit the amount of surface area contact between the adhesive and front surface 32 of fixation sheet 16. One example of a suitable non-permanent adhesive is Ref. No. PS822, manufactured by Polykote Corporation, Easton, Pa.

Switchable decor 18 is formed of plastic and sized commensurately with fixation sheet 16. The thickness of switchable decor 18 is generally between 6 mil (0.006 inch) and 30 mil (0.030 inch), preferably 12-17 mil. Decor 18 also includes an opening 48 sized commensurately with openings 24, 36 of fixation sheet 16 and case 14, respectively. Unlike fixation sheet 16, switchable decor does not include an adhesive. Rather, switchable decor is securely attached to case 14 by non-permanent adhesive 34 on fixation sheet 16.

The adhesive characteristic or “stickiness” of non-permanent adhesive 34 is dependent on the materials it contacts. That is, non-permanent adhesive 34 may have a stronger adherence to one material than a different material. Therefore, depending on the particular non-permanent adhesive that is being used, the particular materials selected for making fixation sheet 16 and switchable decor 18 are generally selected such that the non-permanent adhesive will adhere more strongly to fixation sheet 16 and will adhere less to switchable decor 18. By selecting the appropriate non-permanent adhesive in conjunction with the materials for fixation sheet 16 and switchable decor 18, the switchable decor is more easily separated from fixation sheet 16 and the non-permanent adhesive more securely retained on the fixation sheet.

Switchable decor 18 includes a graphical image or design having black and white, color, text, names, patterns, images, photographs, or combinations of such designs. For example, the designs can include names, logos, slogans, advertisements or combinations of such graphical indicia. The designs may be customized by the user or be provided by the manufacturer of system 10. The design can be provided onto the substrate supporting the design by printing, silk screening, etching, etc. In certain embodiments. Switchable decor may have a luminescent effect (i.e., glow-in-the-dark), for example, as described in U.S. Pat. No. 6,875,525, which is incorporated in its entirety by reference.

In this embodiment, fixation sheet 16 includes a graphic 42 (e.g., a corporate logo). Similarly, as shown in FIG. 4, a rear surface 44 of case 14 may also include a graphic 46 that is printed, embossed or etched thereon.

Referring to FIG. 5, front surface 26 of case 14 includes a lip or ridge 48 that extends around the periphery of backwall 20. Ridge 48 has a height the same or slightly larger than the combined thickness of decor 18 and fixture sheet 16 so that once attached to fixture sheet 16 the edge of switchable decor 18 is protected. In this way, the likelihood that the switchable decor 18 is inadvertently removed is minimized.

In using system 10, the user carefully attaches rear surface 28 of fixation sheet 16 to front surface 26 of case 14 such that non-permanent adhesive 34 on front surface 32 of the fixation sheet is exposed. The user can then attach switchable decor 18 to the non-permanent adhesive on the front surface 32 of fixation sheet 16. Once in place, switchable decor 18 is firmly secured to case 14.

Over time, the graphical image on switchable decor 18 may become worn or the user may desire replacing the decor for a different one. To do so, the user can remove the switchable decor 18 that is on case 14 and replace it with a different switchable decor (e.g., one that may be stored between smartphone 12 and case 14). Because the switchable decors do not include adhesive, they are easily exchanged and stored.

Referring to FIG. 6, a suction tool 60 can be used to facilitate removal of switchable decor 18 from fixation sheet 16. In particular, the suction tool 60 includes a handle 62 attached to a suction cup 64 sized consistent with the size of cutout 38 of fixation sheet 16. Because there is no adhesive associated with cutout 38, the user applies suction cup 64 over and to that portion of switchable decor 18 over the cutout 38 of fixation sheet 16.

Referring to FIG. 7, once suction tool 60 is attached to switchable decor 18 the user can pull on handle 62 to lift the edge of the decor. With an edge 63 of switchable decor 18 lifted, the user can grasp the switchable decor 18 and peel it from the fixation sheet having non-permanent adhesive 34.

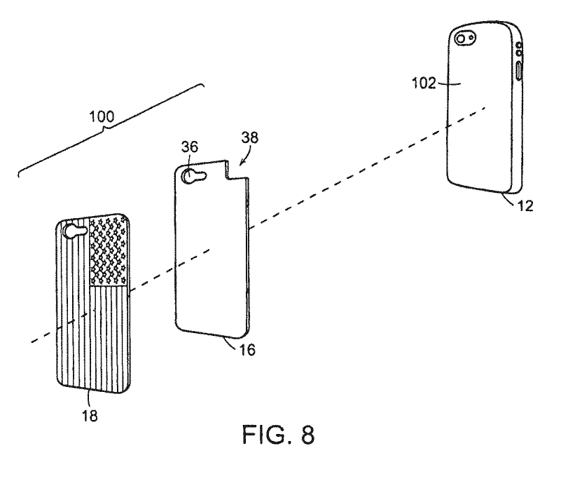

In another embodiment, the case 14 may be eliminated and the fixation sheet 16 applied to directly to an outer surface of the article. For example, referring to FIG. 8, a system 100 includes fixation sheet 16 which is applied directly to an outer rear surface 102 of smartphone 12 as well as switchable decor 18. Switchable decor is attached and removed from fixation sheet 16 in the same manner described above in conjunction with FIGS. 1-6.

In still another embodiment, the fixation sheet 16 is eliminated and non-permanent adhesive 34 is applied directly to the outer surface of the case 14 or to any article including the smartphone 12 without a case. In this way, switchable decor 18 is attached directly to the case or the article. For example, the non-permanent adhesive can be applied directly to the outer rear surface by the manufacturer of the case and covered by a temporary sheet or switchable decor. In that case, the manufacturer would select an appropriate non-permanent adhesive that is suitable for use with the material of the case. For example, as described above, the material used to form case 14 and the particular non-permanent adhesive 34 are selected such that the adhesive adheres more strongly to the material of the case and adheres less strongly to the flexible decor.

It is to be understood that the foregoing description is intended to illustrate and not to limit the scope of the invention, which is defined by the scope of the appended claims.

For example, although non-permanent adhesive 34 is described as being in the form of microspheres, other non-permanent adhesives can be used. Other examples of non-permanent adhesives include removable pressure sensitive adhesives as well as repositionable adhesives. Furthermore, other non-adhesive mechanisms (e.g., magnetic or static) can be substituted for non-permanent adhesive 34.

Also, although a system 10 including a fixation sheet and switchable decor was described above in conjunction with a smartphone it is appreciated that the system can be used with a wide variety of other articles including portable electronic devices (cell phones, laptop computers, tablets, MP3 players and similar devices) as well as other articles such as a luggage tag, light switch plate, frames, books or insert spot in an auto dashboard or the like.

In the embodiments described above in conjunction with FIGS. 1-8, a general approach for allowing a user to change the decorative sheet (e.g., switchable decor 18) was described. This approach relied upon the use of a fixation sheet having a first adhesive that firmly secured the fixation sheet to the article and a second adhesive, less permanent than the first adhesive, to allow the user to change the decorative sheet (e.g., switchable decor). This concept can be extended to the decorative sheet itself

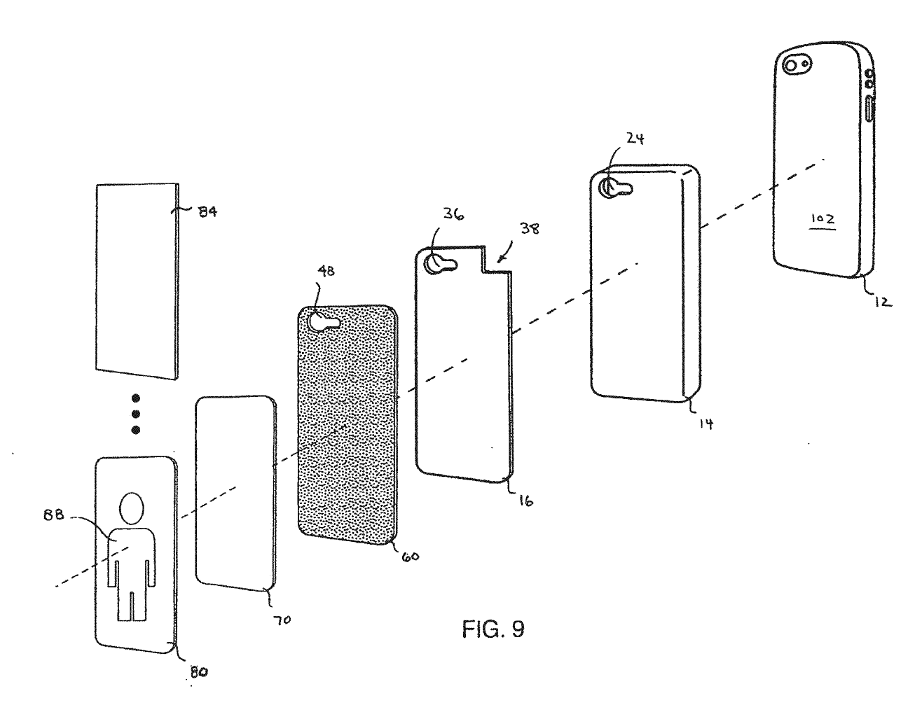

For example, as shown in FIG. 9, a second fixation sheet 70 can be affixed to an exposed outer surface of switchable decor 60 so that yet another and different object can be easily attached or applied to the smartphone or article. Although the object can be of a variety of sizes and shapes, in applications where the article is a smartphone the object is generally planar and flat to allow the smartphone to be easily stored (e.g., placed in a pocket). The object preferably would have the same or at least a similar footprint as the second fixation sheet 70.

In some embodiments, the footprint of the second fixation sheet occupies only a portion of the outer surface of the switchable decor 18. That way, the second fixation sheet 70 and attachable object can be framed or surrounded by the pattern of the switchable decor 18.

As was the case with fixation sheet 18, second fixation sheet 70 includes a non-permanent adhesive agent (i.e., a bonding agent) on a front surface that is less strong than an adhesive or other bonding agent that is used on rear surface. Like fixation sheet 16, fixation sheet 70 would also include an opening 72 sized commensurately with opening 24 of case 14. Furthermore, fixation sheet 70 might also include a cutout (not shown) such that a portion of front surface of the switchable decor 18 is exposed and not covered with an adhesive.

Prior to applying the object on the second fixation sheet 70, a protective liner 84 can cover the front surface of the second fixation sheet and the non-permanent adhesive agent.

In this embodiment, the object is a photograph 8. The use of a second fixation sheet on a switchable decor is particularly attractive and advantageous in an application in which the object is a personal item such as a printed image or a photograph 80 having an image 88. That is, the user can produce relatively two-dimensional items to be attached as a switchable decor with the second fixation sheet 70 acting as the mounting surface.

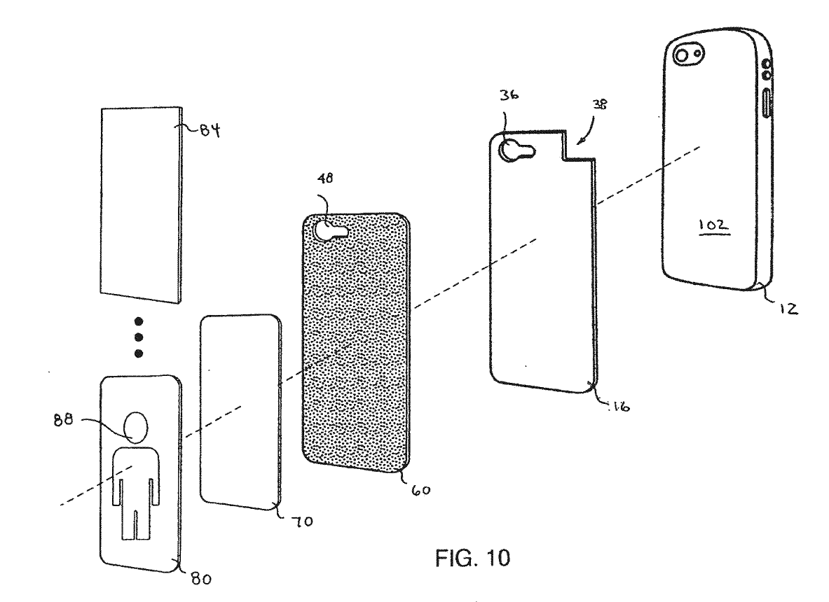

Referring to FIG. 10, similar to the embodiment shown in FIG. 8, the case 14 may be eliminated and the fixation sheet 16 applied to directly to an outer surface of the article. For example, referring to FIG. 10, fixation sheet 16 is applied directly to an outer rear surface 102 of smartphone 12 as well as switchable decor 60. Switchable decor is attached and removed from fixation sheet 16 in the same manner described above in conjunction with FIG. 1.

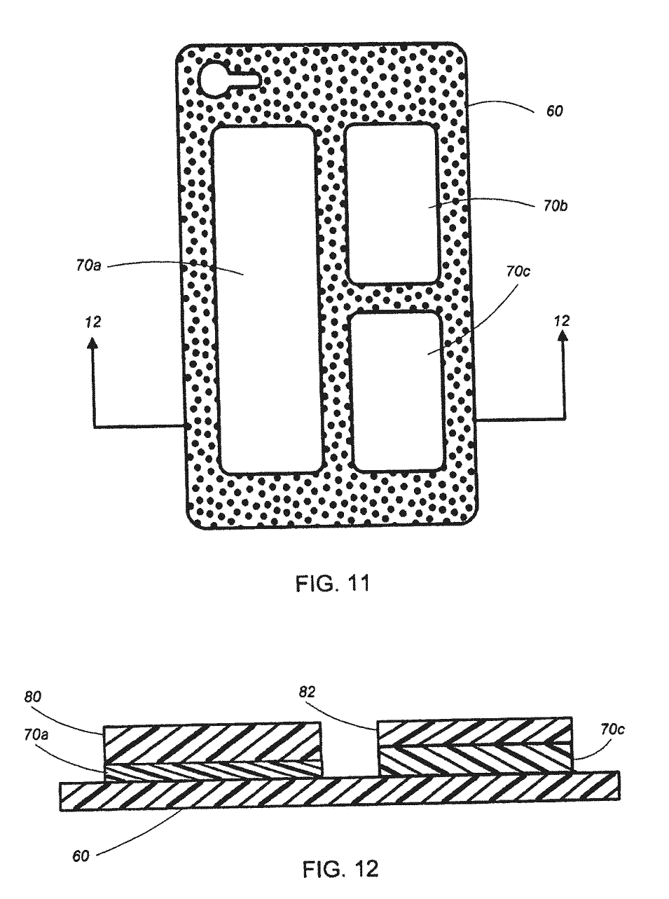

Referring to FIGS. 11 and 12, a fixation sheet might also be composed of a plurality of fixation pieces 70a, 70b, 70c at different positions on switchable decor 18. The different fixation pieces 70a, 70b, 70c might have different adhesive agents with different adhesive characteristics for supporting different types of objects. Or, as shown in FIG. 12, the thickness of one fixation piece 70a might be different than a neighboring fixation piece 70c, for example, such that the overall thickness of a fixation piece 70c and its associated object 82 is the same or similar to the overall thickness of a neighboring, perhaps thicker, fixation piece 70a that supports a thinner but heavier object 80 (here a photograph). Thus, the objects attached to the fixation sheet are substantially uniform, thereby allowing the article (e.g., smartphone) to be stowed in a pocket.

Furthermore, as described above in conjunction with FIGS. 1-8, the non-permanent adhesive might be a microsphere adhesive composed of tiny spheres or a different material with adhesive properties (e.g., silicon).

In a particular embodiment, the photograph 80 can be produced using an instant camera of the type which uses self-developing film to create a chemically developed print shortly after taking the picture. One example of such a system is the Instax® brand of instant still camera marketed by Fujifilm®. For this embodiment, the Instax® “mini” format (62 mm×46 mm) is dimensionally well-suited for being applied to switchable decor 60 having a fixation sheet 70 generally smaller than fixation sheet 16, which is used to attach switchable decor 60 to case 14. In this embodiment in particular, fixation sheet 70 is sized and shaped consistent with the dimensions of the Instax mini-format photograph. The photograph could also be generated by other camera systems including those provided by Polaroid, Fuji, HP Sprocket and other Instant photo systems like printers.

Of course, objects could be substituted for a photograph including objects made of materials including plastics, leather, fur, wood, and fabric.

The systems described above in conjunction with FIGS. 1-12 provide a simple and fun way to decorate, change and personalize the look of the article. The look of the article can be changed without having to replace the entire case or the decal or skin that has adhesive applied directly to it.

There are other advantages of the systems described above when used with particular applications, for example, software stored on a device (e.g., smartphone, tablet, etc.)

Referring to FIG. 13, for example, smartphone 12 includes software, e.g. an application 102 for recognizing an image on a switchable decor. In a particular, application 102 includes a lookup module 104, which receives image data 106 from a digital camera 108 used to capture a digital image of a graphic 109 on the switchable decor 18. Lookup module 104 compares image data 106 with data representative of images 110 stored in a library 112 and, if an appropriate match is found, provides identification data 114 associated with image data 106.

Application 102 also includes a presenter module 116 which receives identification data 114 that is used by the presenter module to acquire a presenter asset 118 associated with the identification data. In one embodiment, presenter asset 116 can point to an address (e.g., a URL) that is used by presenter module to acquire a media presentation 120. In this embodiment, presenter module 116 acts as a browser to acquire the media presentation from a cloud storage or over the Internet via antenna 122. In other embodiments, media presentation 120 could be stored on the smartphone 12 itself along with other pre-stored media presentations. In still other embodiments, the media presentations can be accessed as a combination of two or more of identification data from cloud storage, the Internet or on the mobile device itself.

Media presentation 120 can provide a visual experience, audio experience or both. For example, in the case of an audio experience, media presentation 120 can be audio, such as spoken word or music. In the case of a video experience, media presentation 120 can be in the form of a video or an even more complex multimedia experience, such as a full 3D animation video with music. The media presentation 120 is provided by presenter module 116 to a display 124, speaker 126 or headphone jack 128 of smartphone 12, as would be appropriate, for viewing, listening or both, by a user 130.

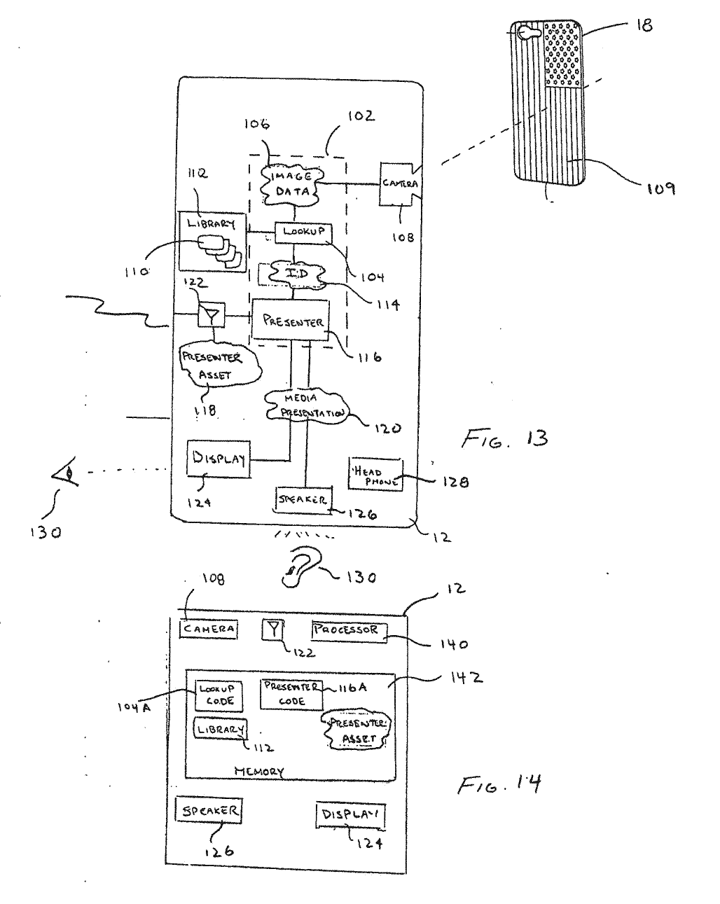

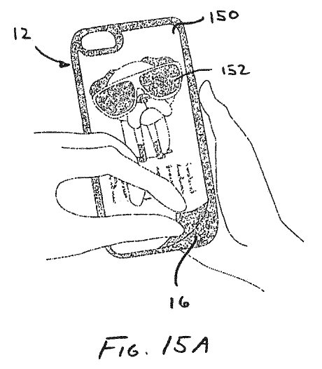

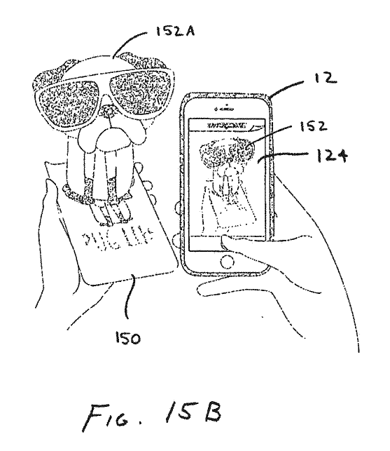

Referring to FIG. 14, for performing the actions described above in conjunction with FIG. 13, smartphone 12 includes a processor 140 and a memory 142, which stores lookup module code 104A, presenter module code 116A, library 112 and, in some cases, presenter asset 118.

Several examples of using a smartphone 12 including a case 14 having a fixation sheet 16 and a switchable decor, as described above in conjunction with FIGS. 1-12, and how such can be used with application 102.

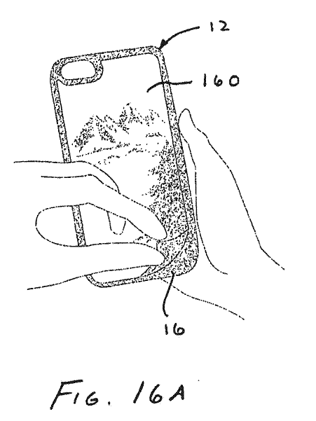

Referring to FIG. 15A, a switchable decor 150 is shown being removed from fixation sheet 16. In this example, switchable decor 150 has an image of a dog wearing sunglasses and underlying text (“PUG LIFE”).

Referring to FIG. 15B, camera 108 of smartphone 12 is used to capture a digital image of the dog wearing sunglasses. As described above, application 102 stored in memory 142 of smartphone 12, accesses a media presentation, which in this case, is a full 3D animation associated with the static image on switchable decor 150. For example, the dog 152 shown on switchable decor 150 begins moving and talking (symbolically depicted here as an enlarged dog 152A).

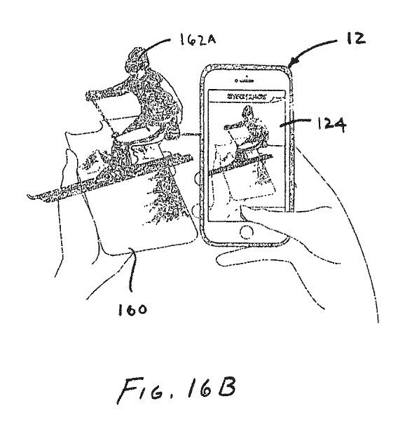

Referring to FIG. 16A, a switchable decor 160 is shown being removed from fixation sheet 16. In this example, switchable decor 160 depicts an image of a landscape showing mountains and trees.

Referring to FIG. 16B, camera 108 of smartphone 12 is used to capture a digital image of the landscape. Application 102 then accesses a media presentation of a video showing a downhill skier transposed over the landscape scene (symbolically depicted here as an enlarged skier 162A).

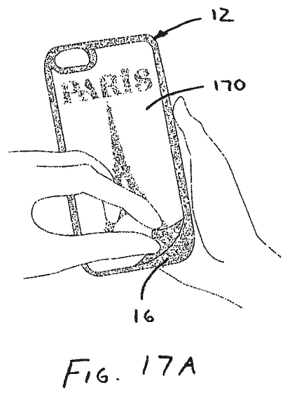

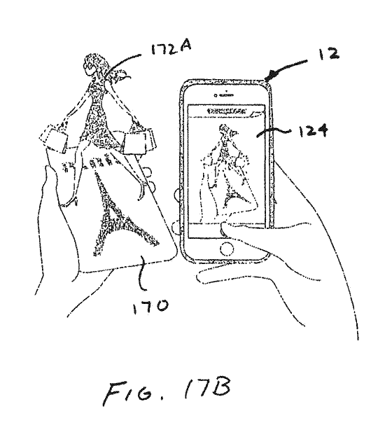

Referring to FIG. 17A, in yet another example, a switchable decor 170 being removed from fixation sheet 16 depicts an image of the Eifel Tower below the word “PARIS.” Referring to FIG. 17B, camera 108 of smartphone 12 is used to capture a digital image of the Eifel Tower, triggering a media presentation in which a woman walking carrying shopping bags springs forth in video form (symbolically depicted here as an enlarged strolling woman 172A).

Referring to FIG. 18, camera 108 can capture static images of multiple switchable decors 150, 160, simultaneously. In this embodiment, application 102 is capable of capturing media presentations associated with both images and is able to trigger a media presentation in the form of a 3D animation in which the moving/talking dog is shown along with the walking woman

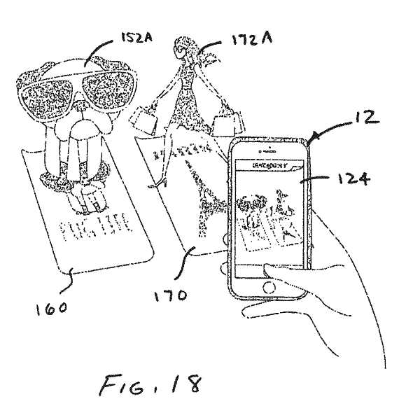

Referring to FIG. 19, in another example, camera 108 captures static images of multiple switchable decors 150, 160, and 170 simultaneously. In this example, a media presentation in the form of a 3D animation that is different than what each individual static image would have triggered. As shown in FIG. 19, the static images of the dog, Eifel Tower and landscape triggers a 3D animation of a rocket 180 soaring across the sky (symbolically depicted here as an enlarged rocket).

With respect to application 102, other embodiments and variations are within the scope of the claims including the following:

Other forms of a two-dimensional indicia can be added along with the graphical or photographic image on the switchable decor. For example, a QR code or watermark type code could be printed or embedded on the switchable decor.

In another embodiment, a combination of all or part of an image on a switchable decor can trigger several different experiences from the same switchable decor. For example, one corner of a switchable decor could trigger the playing of music, another corner of the switchable decor could trigger a video, a middle portion of the switchable decor could trigger a 3D animation, while the overall image of the switchable decor could trigger a link to a website.

In certain embodiments, specific customers can choose unique two-dimensional indicia (e.g., QR code style indicia or watermarks) that can be printed or embedded into their custom switchable decor designs. For example, a customer in the skiing business could add to an image depicting skiing and/or mountains, a code that will trigger the 3D animation skier that will spring off its switchable decor design showing his image as well as the choose unique two-dimensional indicia.

In certain embodiments, application 102, in conjunction with camera 118 or other imaging or scanning device, serves as a reader/scanner that will read/scan a switchable decor and recognize a code that can be either the entire switchable decor, a part of it, a watermark or any other type of codes (e.g., QR codes or the like). Once the code is recognized, an augmented reality (AR) experience, such as a 3D animation, video, web-content, music, photo, web-link and other, will be triggered and the user will be able to experience it coming alive right from the switchable decor.

The AR experience, for example, whether a 3D animation, video, web-content, music, photo, web-link (or combinations of such media) can be changed from time to time on an existing switchable decor. That means that even when the reader recognizes an existing switchable decor and triggers its AR experience, the AR experience can be changed as many times as desired and will always work in conjunction with the software application and the given switchable decor. This will enable an innumerable variety of experiences, stories, advertising, promotion, etc.

In certain embodiments, software application 102 allows the user to record or save the AR Experience (as a picture or video), for example, store the picture or video in the memory of the device. The stored picture or video can then be shared via any number of social channels (Snap, Instagram, Facebook), as well as through text messaging or via email. In addition, the user will be able to create his or her own custom switchable decor using the saved AR experience content.

In other embodiments, software application 102 will enable its user to make selfies, mixing his or her image and the media presentations (e.g., AR Experience) together to create exciting, fun and realistic augmented reality pictures or videos.

Software app 102 can be used in conjunction with an e-store that allows users to purchase mobile device cases, other or extra switchable decors from available collections, extra-branded switchable decors, as well as, creating his or her own custom designs with his or her own photo, art or saved AR experience content.

The media presentations, whether an AR experiences in the form of a 3D animation, video, or music can include brand content (e.g., advertising, promotion, product placements and more from companies and other third parties). The content in those media presentations can be created by anyone from the software application that will offer features to be able to create the user's own AR Experience linked to the user's own custom switchable decor (custom design).

In essence, software application 102 can provide all of the functions that will enable users to leverage infinite swap features from experiencing unlimited and magical AR experiences, saving, sharing, buying and customizing switchable decors and more. Swappable products associated with the software application can be combined to provide truly new and exciting multimedia platform.

It is also important to appreciate that application 102 can be stored on a smartphone of the person who possesses the particular switchable decor on their smartphone case or on someone else's smartphone or other device.

It is also important to appreciate that mobile devices other than a smartphone, such as tablets, having a case and switchable decor can include application 102 for experiencing a media presentation based on a graphic on the switchable decor.

The embodiments described above in conjunction with FIGS. 1-19 are generally related to fun ways to decorate, change and personalize the look of an article (e.g., smartphone, tablet, etc.) without having to replace the entire case or the decal or skin that has adhesive applied directly to it. Furthermore, as discussed above, system 10 included a fixation sheet and switchable decor used in conjunction with portable electronic devices (mobile phones, laptop computers, tablets, MP3 players and similar devices) as well as other articles such as a luggage tag, light switch plate, frames, books or insert spot in an auto dashboard or the like. However, all of these articles generally include a rigid flat surface upon which the fixation sheet is adhered.

Using system 10 on a non-flat and/or a non-rigid surface, such as fabric, has the problem that the decorative sheet or switchable decor is more likely to separate from its fixation member when it is flexed or exposed to heat (e.g., from the sun). Articles made from fabric, leather and flexible plastic do not generally hold their shape unless supported on a rigid surface.

However, increasing the adhesive characteristic (e.g., increasing tackiness) such that it adheres more strongly to the fixation member results in requiring a commensurately greater force required to remove the switchable decor. A person applying this greater force is more likely to deform (e.g., bend, wrinkle) or otherwise mar the switchable decor. For example, to remove a switchable decor that is more firmly attached to the fixation sheet requires the user to grasp a corner or edge of the switchable decor and pull or tug with greater force to remove it. This repeated action will cause the corners and edges to begin to curl upward, thereby deforming the switchable decor, particularly the corners and edges, resulting in a switchable decor with degraded appearance.

Therefore, in certain other embodiments, the adhesion characteristics of the fixation sheet are controlled so that when the fixation sheet is attached to articles that are made from materials that are not rigid and do not inherently have flat surfaces, a corresponding switchable decor can be securely attached and also removed with less risk of damage to the switchable decor.

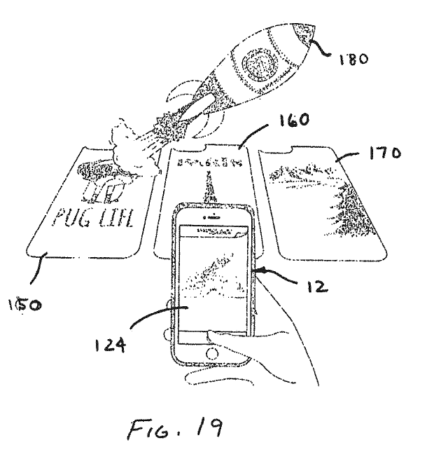

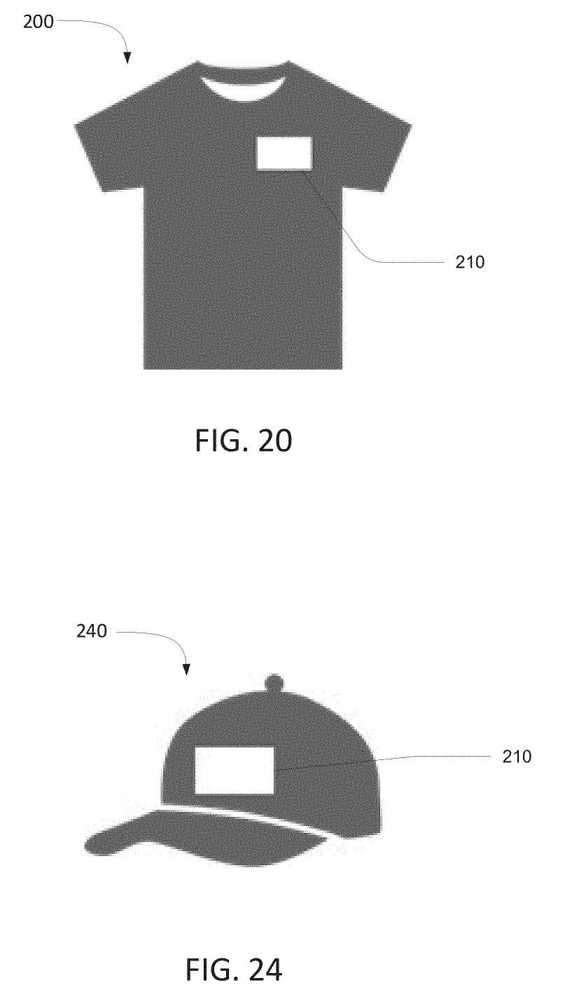

For example, referring to FIG. 20, a T-shirt 200 can include a system 210 having a fixation sheet and switchable decor constructed in the manner described above in conjunction with FIGS. 2 and 3. System 210 is better suited for use on a T-shirt 200 and other articles made from non-rigid materials, but because system 200 is being used on a non-flat and non-rigid surface, it will have different adhesion characteristics than system 10, which is used on a flat, rigid surface. The different adhesion characteristics of system 200 are achieved by applying the adhesive to the fixation sheet in a pattern such that there are regions with adhesive and regions without adhesive. Furthermore, the pattern and shapes of regions with adhesive and regions without adhesive are predetermined depending on a number of factors including the size and shape of the fixation member, the size and shape of the article to which the fixation member is being attached, and the material of the article. A primary goal is to have sufficient tackiness of the fixation member for the switchable decor to stay secured in place while being able to easily switch to a different switchable decor without damaging either switchable decor.

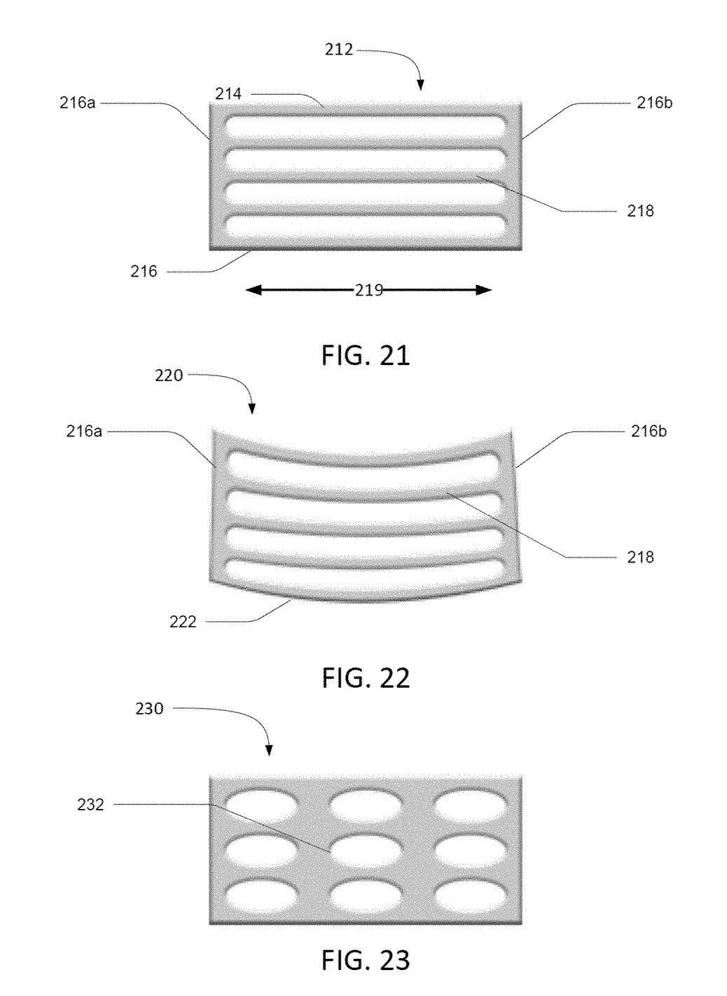

Referring to FIG. 21, a fixation sheet 212 includes adhesive 214 in a pattern resembling a frame portion 216 and a series of parallel extending strips 218 that connect to sides 216a, 216b of the frame. With a switchable decor securely attached to the fixation sheet 212, parallel extending strips 218 of adhesive 214 define a direction arrow 219 that the user will apply a force to more easily remove the switchable decor from the fixation sheet. That is, in FIG. 21, a user would apply a force in the longitudinal direction (left-to-right or right-to-left) of the parallel extending strips 218. Applying a force in a direction transverse to the length of the strips would require much greater force.

Referring to FIG. 22, in another embodiment, a fixation sheet 220 may include a frame portion 222 and a series of curved, parallel extending strips 218 that connect to sides 216a, 216b of the frame.

Referring to FIG. 23, in yet another embodiment, a fixation sheet 230 includes oval-shaped regions 232 that do not have adhesive.

It is appreciated that system 210 can be applied to other articles that are not flat and non-rigid including various garments or articles of clothing (shirts, sweatshirts, jackets). For example, referring to FIG. 24, system 210 is shown attached to a baseball-style cap 240. Baseball-style cap 240 may include an outer surface to which the fixation member is attached that is fabric, leather or plastic. Regardless of the material, the advantages of a system 210 for cap 240 that has a curved shape (even if rigid) has the same benefits as an article made of fabric System 210 can also be attached to other styles of hats including knitted ski caps, beanies, and berets.

It is also appreciated that system 210 can be attached to other articles having non-rigid and no-flat surfaces such as certain toys having curved surfaces (e.g., dolls) or which are made from fabric (stuffed animals).

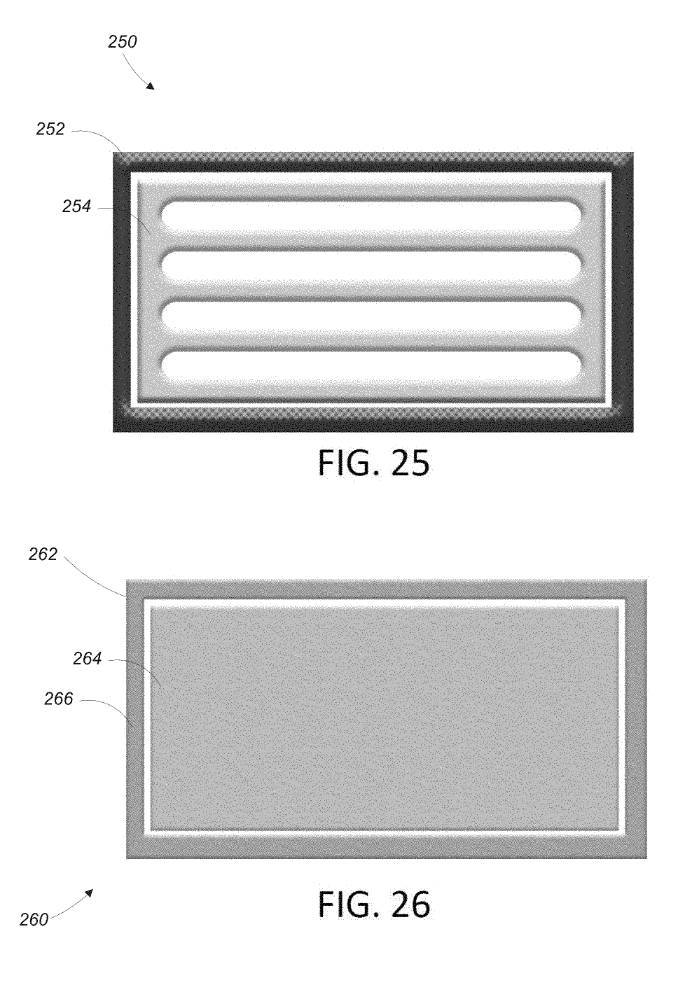

Referring to FIG. 25, in another embodiment, a system 250 includes an embossed support frame 252 that surrounds a fixation member 254. Embossed support frame 252 is in the form of a ridge that stands out in relief from the surface to which the fixation member is attached. Embossed support frame 252 advantageously protects the outer peripheral edge of the switchable decor (not shown) that would be attached to fixation member 254, generally assists in maintaining the switchable decor on the fixation member and minimizes the likelihood that the switchable decor is removed unintentionally or is damaged upon removing. Embossed support frame 252 can be made in a variety of ways including as an embroidered frame surrounding the switchable decor, by thermoforming (Thermo Molding) by stitching or by gluing a premade frame of any of a variety of different materials (fabric, rubber, plastic, leather, etc.) to the outer surface of the article.

In other applications, it may be desirable to address the problem of attaching a switchable decor to a non-rigid or curved outer surface of an article by providing regions of different tackiness to the fixation member.

For example, referring to FIG. 26, a system 260 includes a fixation member 262 having a central region 264 surrounded by an outer frame 266. System 260 is configured such that the tackiness of outer frame 266 is greater than the tackiness of central region 264. Central region 264 could have any shape (e.g., generally rectangular as shown in FIG. 1 or could be patterned to have areas of no adhesive (see, for example, FIGS. 21, 22 and 23).

In the embodiments described above in conjunction with FIGS. 20-24, the articles to which the system 200 was attached had outer surfaces made of fabric. It is appreciated the outer surface of the material can be made of a variety of materials including rubber, plastic, leather or combinations of these materials. Furthermore, using a system 200 having predetermined patterns allows using switchable decors that are made of different materials including fabric, rubber, plastic, leather, etc.

Other embodiments are within the scope of the following claims.

What is claimed is:

1. An apparatus comprising:
an article including a non-flat or non-rigid surface;
a decorative sheet member having:
a first side and a second side, neither of the first and second sides having an adhesive;
a fixation sheet member having:
a third side configured to be attached to the outer surface of the article, the third side including a permanent bonding agent with a first adhesion characteristic; and
a fourth side, opposite the third side and configured to receive one of the first and second sides of the decorative sheet, the fourth side having a repositionable material with a second adhesion characteristic, the second adhesion characteristic being less permanent than the first adhesion characteristic.

2. The apparatus of claim 1 wherein the decorative sheet member and the fixation sheet member are configured such that when the decorative sheet is removed from the fourth side of the fixation sheet, the repositionable material remains on the fourth side of the fixation sheet member.

3. The apparatus of claim 1 wherein the decorative sheet member is formed of a first material, the fixation sheet member is formed of a second material and the repositionable material adheres more strongly to the second material than to the first material.

4. The apparatus of claim 1 wherein the decorative sheet member has a predetermined dimension that is commensurate in size with a predetermined dimension of the fixation sheet member.

5. The apparatus of claim 1 wherein the decorative sheet member has a thickness a range between 4 mil (0.004 inch) and 50 mil (0.050 inch).

6. The apparatus of claim 1 wherein the first side of the decorative sheet member includes a photographic, graphical or textual image.

7. The apparatus of claim 1 wherein the fourth side has a first region including the repositionable material and a second region that does not include the repositionable non-adhesive material.

8. The apparatus of claim 7 wherein the second region has a first predetermined shape.

9. The apparatus of claim 1 wherein the non-rigid surface of the article is formed of fabric.

10. The apparatus of claim 9 wherein the article is in the form of a clothing.

11. The apparatus of claim 10 wherein the clothing is a shirt.

12. The apparatus of claim 10 wherein the clothing is a hat.

13. The apparatus of claim 9 wherein the article is in the form of a toy.

14. The apparatus of claim 13 wherein the toy is a stuffed toy.

15. The apparatus of claim 1 wherein the non-flat surface is curved.

16. The apparatus of claim 1 wherein the repositionable material is an adhesive.

17. The apparatus of claim 1 wherein the repositionable material is a non-adhesive.

18. The apparatus of claim 17 wherein the repositionable non-adhesive material incudes microspheres.

19. The apparatus of claim 1 wherein the fixation sheet member includes a frame region surrounding a central region.

20. The apparatus of claim 19 wherein the central region has the second adhesion characteristic and the frame region has a third adhesion characteristic greater than the second adhesion characteristic.
